(19) United States
(12) Patent Application Publication
(10) Pub. No.: US 2025/0346234 A1
(43) Pub. Date: Nov. 13, 2025

(54) VEHICLE STEERING SYSTEM CONTROL

(71) Applicant: Ford Global Technologies, LLC, Dearborn, MI (US)

(72) Inventors: Rahul Reddy Nagavally, Dearborn, MI (US); Anup Cherukuri, Windsor/Ontario (CA); Nitendra Nath, Troy, MI (US)

(73) Assignee: Ford Global Technologies, LLC, Dearborn, MI (US)

(21) Appl. No.: 18/660,531

(22) Filed: May 10, 2024

(51) Int. Cl. B60W 40/02; B60W 60/00

(52) U.S. Cl. CPC B60W 40/02; B60W 60/0059; B60W 2555/20

(57) ABSTRACT

A computer includes a processor and a memory, and the memory stores instructions executable by the processor to determine a weather classification for an environment surrounding a vehicle, select a steering mode for the vehicle based on the weather classification, and operate a steering system of the vehicle according to the selected steering mode. The steering mode is selected from a hands-free steering mode, a hands-on-wheel steering mode, and a manual steering mode.

### BACKGROUND

Advanced driver assistance systems (ADAS) are electronic technologies that assist drivers in driving and parking functions. Examples of ADAS include forward proximity detection, lane-departure detection, blind-spot detection, braking actuation, adaptive cruise control, and lane-keeping assistance systems.

### BRIEF DESCRIPTION OF THE DRAWINGS

FIG. 1 is a block diagram of an example vehicle.

FIG. 2 is a top view of the vehicle in an example environment.

FIG. 3 is a flowchart of an example process for selecting a steering mode and operating the vehicle according to the steering mode.

### DETAILED DESCRIPTION

This disclosure describes techniques for controlling operation of a steering system of a vehicle based on a weather classification. A computer on board the vehicle determines the weather classification for an environment surrounding a vehicle, selects a steering mode for the vehicle based on the weather classification, and operates the steering system according to the selected steering mode. The steering mode is selected from a hands-free steering mode, a hands-on-wheel steering mode, and a manual steering mode. For example, the weather classification may be severe, medium, or mild. The computer may permit only the manual steering mode in response to severe weather (i.e., block the hands-free and hands-on-wheel steering modes), additionally permit the hands-on-wheel steering mode in response to medium weather, and permit any of the steering modes in response to mild weather. The computer may then actuate the steering system according to whichever of the permitted steering modes is chosen by the operator. The computer blocks the operator from choosing, and blocks the steering system from actuating according to, any of the unpermitted modes.

A computer includes a processor and a memory, and the memory stores instructions executable by the processor to determine a weather classification for an environment surrounding a vehicle, select a steering mode for the vehicle based on the weather classification, and operate a steering system of the vehicle according to the selected steering mode. The steering mode is selected from a hands-free steering mode, a hands-on-wheel steering mode, and a manual steering mode.

In an example, the instructions may further include instructions to block selection of the hands-free steering mode and block selection of the hands-on-wheel steering mode in response to the weather classification being severe weather.

In an example, the instructions may further include instructions to block selection of the hands-free steering mode and permit selection of the hands-on-wheel steering mode in response to the weather classification being medium weather.

In an example, the instructions may further include instructions to permit selection of the hands-free steering mode and permit selection of the hands-on-wheel steering mode in response to the weather classification being mild weather.

In an example, the instructions to determine the weather classification may include instructions to select the weather classification from severe weather, medium weather, and mild weather.

In an example, the instructions may further include instructions to determine a confidence value for detection of a road lane by a sensor on board the vehicle, and determine the weather classification based on the confidence value.

In an example, the instructions may further include instructions to determine the weather classification based on inertial sensor data indicating motion of the vehicle. In a further example, the instructions may further include instructions to determine a confidence value for detection of a road lane by a sensor on board the vehicle, and determine the weather classification based on an interaction between the confidence value and the inertial sensor data.

In an example, the instructions may further include instructions to change the weather classification in response to sensor data satisfying an instantaneous condition for at least a minimum length of time within a preset time window. In a further example, the sensor data satisfying the instantaneous condition may include a confidence value for detection of a road lane by a sensor on board the vehicle.

In another further example, the sensor data satisfying the instantaneous condition may include inertial sensor data indicating motion of the vehicle.

In another further example, the sensor data satisfying the instantaneous condition may include perception data of the environment surrounding the vehicle.

In an example, the instructions may further include instructions to operate the steering system to direct the vehicle toward a center of a lane of travel in response to the selected steering mode being the hands-free steering mode.

In an example, the instructions may further include instructions to operate the steering system to direct the vehicle toward a center of a lane of travel in response to the selected steering mode being the hands-on-wheel steering mode.

A method includes determining a weather classification for an environment surrounding a vehicle, selecting a steering mode for the vehicle based on the weather classification, and operating a steering system of the vehicle according to the selected steering mode. The steering mode is selected from a hands-free steering mode, a hands-on-wheel steering mode, and a manual steering mode.

In an example, the method may further include blocking selection of the hands-free steering mode and blocking selection of the hands-on-wheel steering mode in response to the weather classification being severe weather.

In an example, the method may further include blocking selection of the hands-free steering mode and permitting selection of the hands-on-wheel steering mode in response to the weather classification being medium weather.

In an example, the method may further include permitting selection of the hands-free steering mode and permitting selection of the hands-on-wheel steering mode in response to the weather classification being mild weather.

In an example, the method may further include changing the weather classification in response to sensor data satisfying an instantaneous condition for at least a minimum length of time within a preset time window.

In an example, the method may further include operating the steering system to direct the vehicle toward a center of a lane of travel in response to the selected steering mode being one of the hands-free steering mode or the hands-on-wheel steering mode.

With reference to the Figures, wherein like numerals indicate like parts throughout the several views, a computer 105 includes a processor and a memory, and the memory stores instructions executable by the processor to determine a weather classification for an environment 200 surrounding a vehicle 100, select a steering mode for the vehicle 100 based on the weather classification, and operate a steering system 110 of the vehicle 100 according to the selected steering mode. The steering mode is selected from a hands-free steering mode, a hands-on-wheel steering mode, and a manual steering mode.

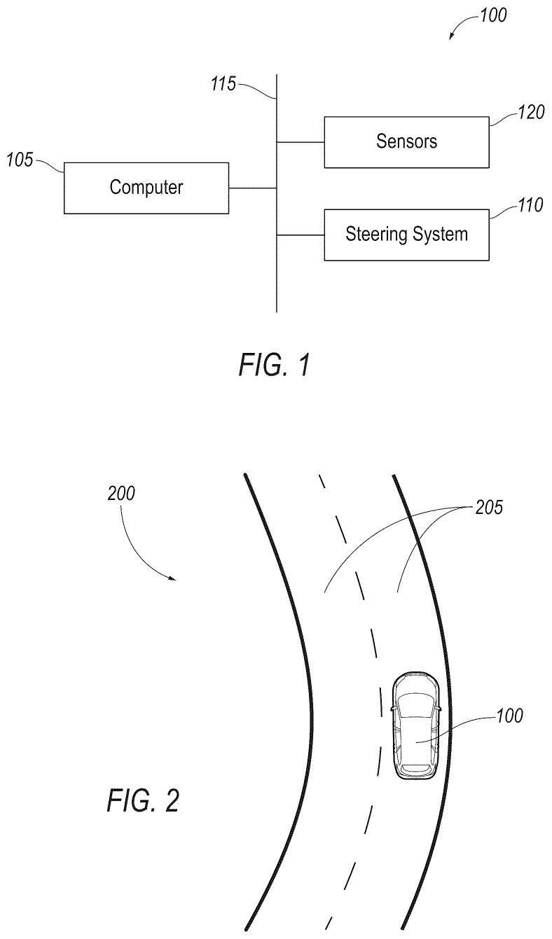

With reference to FIG. 1, the vehicle 100 may be any passenger or commercial automobile such as a car, a truck, a sport utility vehicle, a crossover, a van, a minivan, a taxi, a bus, etc. The vehicle 100 may include the computer 105, a communications network 115, sensors 120, and the steering system 110.

The computer 105 is a microprocessor-based computing device, e.g., a generic computing device including a processor and a memory, an electronic controller or the like, a field-programmable gate array (FPGA), an application-specific integrated circuit (ASIC), a combination of the foregoing, etc. Typically, a hardware description language such as VHDL (VHSIC (Very High Speed Integrated Circuit) Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. The computer 105 can thus include a processor, a memory, etc. The memory of the computer 105 can include media for storing instructions executable by the processor as well as for electronically storing data and/or databases, and/or the computer 105 can include structures such as the foregoing by which programming is provided. The computer 105 can be multiple computers coupled together.

The computer 105 may transmit and receive data through the communications network 115. The communications network 115 may be, e.g., a controller area network (CAN) bus, Ethernet, WiFi, Local Interconnect Network (LIN), onboard diagnostics connector (OBD-II), and/or any other wired or wireless communications network. The computer 105 may be communicatively coupled to the sensors 120, the steering system 110, and other components via the communications network 115.

The sensors 120 may provide data about operation of the vehicle 100, for example, wheel speed, wheel orientation, and engine and transmission data (e.g., temperature, fuel consumption, etc.). The sensors 120 may detect the location and/or orientation of the vehicle 100. For example, the sensors 120 may include global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. The sensors 120 may detect the external world, e.g., objects and/or characteristics of surroundings of the vehicle 100, such as other vehicles, road lane markings, traffic lights and/or signs, road users, etc. For example, the sensors 120 may include radar sensors, ultrasonic sensors, scanning laser range finders, light detection and ranging (lidar) devices, and image processing sensors such as cameras. The sensors 120 may detect whether the operator of the vehicle 100 is placing their hand(s) on the steering wheel. For example, the sensors 120 may include a capacitive sensor on the steering wheel, a torque sensor on the steering column, a camera with a field of view encompassing the steering wheel, etc.

The steering system 110 is typically a conventional vehicle steering subsystem and controls the turning of the wheels. The steering system 110 may be a rack-and-pinion system with electric power-assisted steering, a steer-by-wire system, as both are known, or any other suitable system. The steering system 110 can include an electronic control unit (ECU) or the like that is in communication with and receives input from the computer 105 and/or a human operator. The human operator may control the steering system 110 via, e.g., a steering wheel.

With reference to FIG. 2, the computer 105 may be programmed to receive perception data from the sensors 120. The perception data may include image data from cameras and range data from radars, lidars, and/or ultrasonic sensors. The sensors 120 that produce the perception data may be fixed to the body of the vehicle 100 and oriented in different directions away from the vehicle 100, e.g., forward-facing, rear-facing, side-facing, etc. The perception data covers portions of the environment 200 surrounding the vehicle 100.

The computer 105 may be programmed to receive inertial sensor data from the sensors 120. The inertial sensor data may include data from one or more IMUs, MEMSs, gyroscopes, etc. The inertial sensor data indicates motion of the vehicle 100, e.g., linear velocity, angular velocity, linear acceleration, angular acceleration, components of the foregoing, etc.

The computer 105 may be programmed to detect a road lane 205 in data from one or more of the sensors 120 on board the vehicle 100, e.g., based on the perception data, e.g., image data from a camera of the sensors 120. The computer 105 may use any conventional object-recognition technique suitable for identifying the road lane 205, e.g., lane lines defining the road lane 205. For example, the computer 105 may execute a machine-learning model such as a deep neural network, e.g., PersFormer for detecting lane lines. The machine-learning model may be trained on camera images from the same perspectives as the cameras on board the vehicle 100, annotated with identifications of the lane lines to serve as ground truth.

The computer 105 may be programmed to determine a confidence value for the detection of the road lane 205 by the sensor on board the vehicle 100. For example, the machine-learning model may output a score with the detection indicating the confidence of the detection, as is known.

The computer 105 is programmed to determine the weather classification. For the purposes of this disclosure, a “weather classification” is a description of an overall state of the weather. In particular, the weather classification may relate to the aspects of the weather that affect the operation of the vehicle 100, e.g., precipitation, visibility, temperature, etc. The computer 105 may determine the weather classification by selecting from a ranking of possible weather classifications, e.g., an ordered list or numerical scale. The ranking may represent the severity of the weather, e.g., the relative difficulty of operating a vehicle in the weather. For example, greater precipitation, lower visibility, or temperature below freezing may correspond to higher severity. The ranking may have at least three levels, which will be referred to as severe weather, medium weather, and mild weather. The levels of the ranking may be represented in the memory of the computer 105 with a numerical score, e.g., 3 for severe weather, 2 for medium weather, and 1 for mild weather. The ranking may instead have more than three levels.

The computer 105 is programmed to determine the weather classification for the environment 200 surrounding the vehicle 100. The environment 200 surrounding the vehicle 100 is a geographic area through which the vehicle 100 is traveling and whose weather the vehicle 100 is currently experiencing.

The computer 105 is programmed to determine the weather classification for the environment 200 surrounding the vehicle 100 based on the confidence value for the detection of the road lane 205, the inertial sensor data indicating motion of the vehicle 100, and/or the perception data of the environment 200 surrounding the vehicle 100. In other words, the confidence value for the detection of the road lane 205, the inertial sensor data, and the perception data are inputs for determining the weather classification. The computer 105 may determine the weather classification based on one of the confidence value for the detection of the road lane 205, the inertial sensor data, or the perception data. Alternatively or additionally, the computer 105 may determine the weather classification based on an interaction between two or three of the confidence value for the detection of the road lane 205, the inertial sensor data, and the perception data.

The computer 105 may determine the weather classification by selecting the weather classification from the ranking of possible weather classifications, e.g., from severe weather, medium weather, and mild weather. For example, the computer 105 may store the weather classification in memory, and the computer 105 may change the weather classification in response to a criterion being satisfied. The computer 105 may store a plurality of criteria for changing the weather classification. The criteria may be for one or a combination of the detection of the road lane 205, the inertial sensor data, and the perception data, as will be described below.

Each criterion may be associated with setting the weather classification to one of the possible weather classifications. Multiple criteria may be stored for setting the weather classification to the same possible weather classification, e.g., a first criterion is associated with severe weather, a second criterion is associated with mild weather, a third criterion is also associated with severe weather, etc. The computer 105 may be programmed to, in response to multiple criteria being satisfied, select the most severe weather classification from the possible weather classifications associated with the satisfied criteria. For example, if two criteria associated with mild weather and one criterion associated with medium weather are satisfied, the computer 105 determines that the weather classification is medium weather.

The criteria may be based on instantaneous conditions. For the purposes of this disclosure, “instantaneous” is defined as present or occurring at a specific instant. For example, an instantaneous condition using image data from a camera of the vehicle 100 may apply a test to a most recent image returned by the camera, and an instantaneous condition using inertial data may use a single value of lateral acceleration rather than averaging lateral acceleration over time.

For example, at least one criterion may be sensor data satisfying an instantaneous condition for at least a minimum length of time within a preset time window, e.g., the criterion is satisfied if the instantaneous condition is satisfied for at least 8 seconds out of a time window of 10 seconds. The instantaneous condition may be for the detection of the road lane 205, the inertial sensor data, the perception data, or an interaction between two or three of the foregoing, as will be described in turn below. The minimum length of time and the preset time window may each be preset time durations stored in the memory of the computer 105. The minimum length of time may be equal to the preset time window, i.e., the criterion is satisfied if the instantaneous condition is satisfied continuously for the minimum length of time/preset time window. Alternatively, the minimum length of time may be less than the preset time window, e.g., the criterion is satisfied if the instantaneous condition is satisfied for most of the time window, such as 8 seconds out of 10 seconds. The computer 105 may store different criteria with different instantaneous conditions, and different minimum lengths of time and different time windows may be associated with the criteria. The use of the minimum length of time and preset time window may serve a similar purpose as hysteresis, so that the computer 105 does not oscillate too quickly between weather classifications, and a change in the weather classification is more likely to represent a true change in the weather.

As one example of an instantaneous condition, the sensor data satisfying the instantaneous condition may include the confidence value for the detection of the road lane 205. The instantaneous condition may be that the confidence value is above or below a threshold. For example, the instantaneous condition associated with changing the weather classification to severe weather may be that the confidence value is below a first (lower) threshold; the instantaneous condition associated with changing the weather classification to medium weather may be that the confidence value is between the first threshold and a second (higher) threshold; and the instantaneous condition associated with changing the weather classification to mild weather may be that the confidence value is above the second threshold.

As another example, the sensor data satisfying the instantaneous condition may include the inertial sensor data indicating motion of the vehicle 100. The instantaneous condition may be that an indicator of lateral motion is above a threshold. The indicator of lateral motion may be, e.g., lateral acceleration and/or yaw rate. For example, the instantaneous condition associated with changing the weather classification to severe weather may be that the lateral motion is above a threshold, and the instantaneous condition associated with changing the weather classification to mild weather may be that the lateral motion is below the threshold.

As another example, the sensor data satisfying the instantaneous condition includes perception data of the environment 200 surrounding the vehicle 100. The instantaneous condition may be the presence of some characteristic in the image data, e.g., sun glare, fog, rain, etc. For example, the instantaneous condition associated with changing the weather classification to severe weather may be that sun glare encompasses a first (higher) threshold proportion of an image frame; the instantaneous condition associated with changing the weather classification to medium weather may be that sun glare encompasses a proportion of the image frame between the first threshold proportion and a second (lower) threshold proportion; and the instantaneous condition associated with changing the weather classification to mild weather may be that sun glare encompasses less than the second threshold.

As another example, the sensor data satisfying the instantaneous condition includes perception data of the environment 200 surrounding the vehicle 100. The computer 105 may determine an instantaneous weather assessment based on the perception data. For example, the computer 105 may execute a machine-learning program such as an image-recognition program trained to identify weather, e.g., a convolutional neural network. A convolutional neural network includes a series of layers, with each layer using the previous layer as input. Each layer contains a plurality of neurons that receive as input data generated by a subset of the neurons of the previous layers and generate output that is sent to neurons in the next layer. Types of layers include convolutional layers, which compute a dot product of a weight and a small region of input data; pool layers, which perform a downsampling operation along spatial dimensions; and fully connected layers, which generate based on the output of all neurons of the previous layer. The final layer of the convolutional neural network generates a score for each potential weather assessment (e.g., clear, overcast, heavy rain, light rain, heavy snow, snow flurry, etc.), and the final output is the weather assessment with the highest score. Alternatively, the machine-learning program may be a regression network taking the perception data as input, and the final output may be a numerical score indicating a severity of the weather. The instantaneous condition may be the instantaneous weather assessment, e.g., the final output of the machine-learning program. The instantaneous conditions associated with changing the weather classification to severe weather, medium weather, and mild weather may be sets of weather assessments (e.g., clear or overcast associated with mild weather, light rain or snow flurry associated with medium weather, heavy rain or heavy snow associated with severe weather) or numerical ranges for a numerical score indicating the weather assessment.

As another example, the sensor data satisfying the instantaneous condition includes an interaction between the confidence value for the detection of the road lane 205 and the inertial sensor data. For example, the computer 105 may maintain the weather classification at the same value, i.e., not change the weather classification, in response to a decrease in the confidence value that co-occurs with a change in the heading of the vehicle 100, even if the confidence value decreases below the first or second threshold for the instantaneous condition described above for at least the minimum length of time within the preset time window. For another example, the computer 105 may change the weather classification, e.g., from severe weather to medium or mild weather or from medium weather to mild weather, in response to an increase in the confidence value that co-occurs with a change in the heading of the vehicle 100. For the criterion associated with the instantaneous condition of this example, the minimum length of time may be less than the minimum length of time for other criteria, e.g., less than the minimum length of time for the criterion for changing the weather classification to medium or severe weather based on perception data.

As another example, the sensor data satisfying the instantaneous condition includes an interaction between the perception data and the inertial sensor data. For example, the computer 105 may maintain the weather classification at the same value, i.e., not change the weather classification, in response to a sun glare that co-occurs with a change in the heading of the vehicle 100, even if the sun glare exceeds the first or second threshold proportion of the image frame for the instantaneous condition described above for at least the minimum length of time within the preset time window. For another example, the computer 105 may change the weather classification, e.g., from severe weather to medium or mild weather or from medium weather to mild weather, in response to a disappearance of sun glare that co-occurs with a change in the heading of the vehicle 100. For the criterion associated with the instantaneous condition of this example, the minimum length of time may be less than the minimum length of time for other criteria, e.g., less than the minimum length of time for the criterion for changing the weather classification to medium or severe weather based on perception data.

The computer 105 is programmed to select a steering mode for the vehicle 100. The steering mode defines the source of input for operating the steering system 110, e.g., the computer 105 or the operator, as well as the form of operator interaction with the steering system 110, e.g., whether the operator's hands remain on the steering wheel or may be removed. The steering mode is selected from a plurality of different steering modes including a hands-free steering mode, a hands-on-wheel steering mode, a manual steering mode (as will be described in turn below), and possibly other steering modes.

The computer 105 is programmed to select a steering mode for the vehicle 100 based on the weather classification. The selection may be different for each of severe weather, medium weather, and mild weather. For example, the computer 105 may block and permit different ones of the steering modes for each of severe weather, medium weather, and mild weather, meaning that the operator's choice of steering mode is restricted to the permitted steering modes. As will be described below, the computer 105 actuates the steering system 110 according to a permitted steering mode and not according to a blocked steering mode. The computer 105 may block selection of the hands-free steering mode and block selection of the hands-on-wheel steering mode in response to the weather classification being severe weather. Thus, the computer 105 may permit only the manual steering mode in response to the weather classification being severe weather. The computer 105 may block selection of the hands-free steering mode and permit selection of the hands-on-wheel steering mode in response to the weather classification being medium weather. Thus, the computer 105 may permit an operator to select either the hands-on-wheel steering mode or the manual steering mode (but not the hands-free steering mode) in response to the weather classification being medium weather. The computer 105 may permit selection of the hands-free steering mode and permit selection of the hands-on-wheel steering mode in response to the weather classification being mild weather. Thus, the computer 105 may permit the operator to select any of the steering modes in response to the weather classification being mild weather. The use of three (or more) possible weather classifications allows for the computer 105 to block the hands-free steering mode while permitting the hands-on-wheel steering mode, rather than either blocking or permitting all driver assistance.

The computer 105 is programmed to operate, i.e., actuate, the steering system 110 according to the selected steering mode. In the hands-free steering mode, the computer 105 provides the input for operating the steering system 110, and the operator is not expected to place their hands on the steering wheel. For example, the computer 105 may be programmed to operate the steering system 110 to direct the vehicle 100 toward a center of the road lane 205 of travel in response to the selected steering mode being the hands-free steering mode. The computer 105 may, in response to the selected steering mode being the hands-free steering mode, maintain the directing of the vehicle 100 toward the center of the road lane 205 of travel even if the hands of the operator are not detected on the steering wheel. The hands-free steering mode may be restricted to particular situations, e.g., particular types of roads such as expressways.

In the hands-on-wheel steering mode, the computer 105 provides the input for operating the steering system 110, and the operator is expected to place their hands on the steering wheel even though not actively turning the steering wheel. For example, the computer 105 may be programmed to operate the steering system 110 to direct the vehicle 100 toward the center of the road lane 205 of travel in response to the selected steering mode being the hands-on-wheel steering mode. The computer 105 may, in response to the selected steering mode being the hands-on-wheel steering mode, perform an action in response to detecting an absence of the hands of the operator on the steering wheel. The computer 105 may detect the absence of the hands of the operator on the steering wheel based on data from the sensors 120, e.g., from a capacitive sensor on the steering wheel, a torque sensor on the steering column, etc. The action may include one or more of outputting a message to the operator to place their hands on the steering wheel, transitioning to the manual steering mode, braking the vehicle 100, etc. For example, the computer 105 may output one or more messages to the operator to place their hands on the steering wheel and wait for a period of time before transitioning to the manual steering mode or braking the vehicle 100.

In the manual steering mode, the operator provides the input for operating the steering system 110 by placing their hands on the steering wheel to actively turn the steering wheel. The computer 105 may be programmed to, in response to the selected steering mode being the manual steering mode, operate the steering system 110 to turn the wheels of the vehicle 100 according to a steering ratio applied to an angle of the steering wheel.

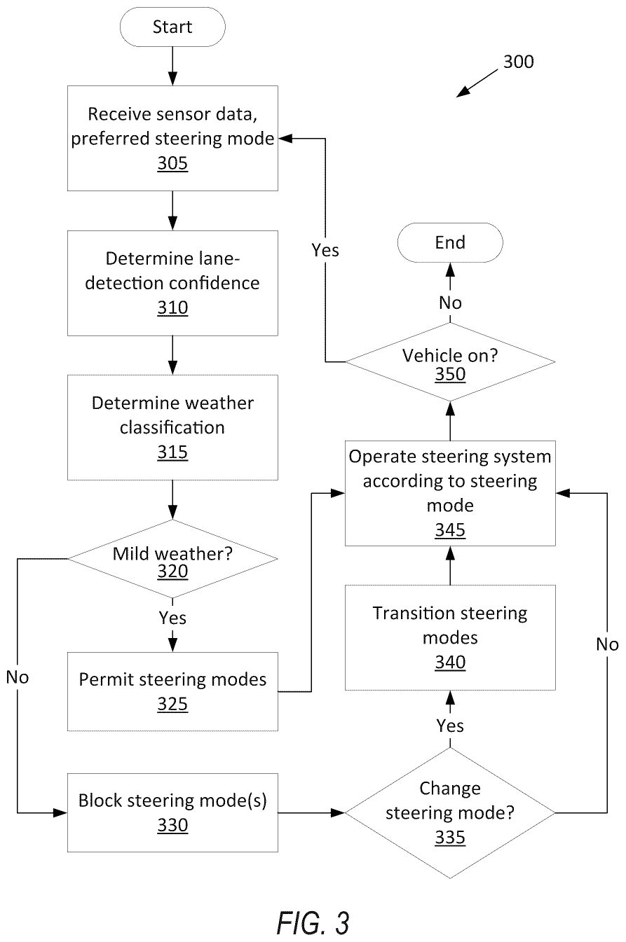

FIG. 3 is a flowchart illustrating an example process 300 for selecting a steering mode and operating the vehicle 100 according to the steering mode. The memory of the computer 105 stores executable instructions for performing the steps of the process 300 and/or programming can be implemented in structures such as mentioned above. As a general overview of the process 300, the computer 105 receives data from the sensors 120, determines the confidence value for detection of the road lane 205, and determines the weather classification. In response to mild weather, the computer 105 permits the selection of any of the steering modes. In response to medium or severe weather, the computer 105 blocks at least one of the steering modes. In response to the current steering mode being blocked, the computer 105 transitions to a different steering mode. The computer 105 operates the vehicle 100 according to the current steering mode. The process 300 continues for as long as the vehicle 100 remains on.

The process 300 begins in a block 305, in which the computer 105 receives data from the sensors 120, including the perception data and the inertial data, as described above. The computer 105 receives a current steering mode, e.g., by accessing the steering mode stored in the memory of the computer 105, i.e., the most recently selected steering mode. If the vehicle 100 has just started and no steering mode has been selected yet, then the current steering mode is the manual steering mode. The current steering mode may have been set by an input from the operator selecting the steering mode from among the steering modes that were permitted at the time of the input.

Next, in a block 310, the computer 105 detects the road lane 205 and determines the confidence value for the detection of the road lane 205 by one or more of the sensors 120 on board the vehicle 100, as described above.

Next, in a block 315, the computer 105 determines the weather classification based on the perception data and inertial data from the block 305 and the confidence value from the block 310, e.g., according to which criteria are satisfied by the data, as described above.

Next, in a decision block 320, the computer 105 determines whether the weather classification is mild weather, medium weather, or severe weather. In response to the weather classification being mild weather, the process 300 proceeds to a block 325. In response to the weather classification being medium weather or severe weather, the process 300 proceeds to a block 330.

In the block 325, the computer 105 permits selection of any of the steering modes, e.g., the hands-free steering mode, the hands-on-wheel steering mode, or the manual steering mode, by the operator of the vehicle 100. After the block 325, the process 300 proceeds to a block 345.

In the block 330, the computer 105 blocks selection of at least one of the steering modes according to the weather classification, as described above. The computer 105 blocks selection of the hands-free steering mode and blocks selection of the hands-on-wheel steering mode in response to the weather classification being severe weather. The computer 105 blocks selection of the hands-free steering mode and permits selection of the hands-on-wheel steering mode in response to the weather classification being medium weather.

Next, in a decision block 335, the computer 105 determines whether to change the steering mode. The computer 105 determines whether the current steering mode from the block 305 is one of the blocked steering modes from the block 330. In response to the current steering mode being blocked, the process 300 proceeds to a block 340. In response to the current steering mode being permitted, the process 300 proceeds to the block 345.

In the block 340, the computer 105 transitions from the blocked current steering mode to one of the permitted steering modes, as described above. For example, the computer 105 may transition from the hands-on-wheel steering mode to the manual steering mode. For another example, the computer 105 may transition from the hands-free steering mode to the hands-on-wheel steering mode if the hands-on-wheel steering mode is permitted (i.e., medium weather) and to the manual steering mode if the hands-on-wheel steering mode is also blocked (i.e., severe weather). Alternatively, the computer 105 may transition from the hands-free steering mode to the manual steering mode regardless of whether the hands-on-wheel steering mode is blocked or permitted (i.e., medium or severe weather). If the hands-on-wheel steering mode is permitted (i.e., medium weather), the operator may then choose to activate the hands-on-wheel steering mode from the manual steering mode. The current steering mode in memory is set to the steering mode into which the computer 105 transitions. After the block 340, the process 300 proceeds to the block 345.

In the block 345, the computer 105 operates the steering system 110 of the vehicle 100 according to the current steering mode, either from the block 305 if permitted or from the block 340 if a transition occurred.

Next, in a decision block 350, the computer 105 determines whether the vehicle 100 is still on, i.e., is in an on state. For the purposes of this disclosure, “on state” is defined as the state of the vehicle 100 in which full electrical energy is provided to electrical components of the vehicle 100 and the vehicle 100 is ready to be driven, e.g., the engine is running; “off state” is defined as the state of the vehicle 100 in which a low amount of electrical energy is provided to selected electrical components of the vehicle 100, typically used when the vehicle 100 is being stored; and “accessory-power state” is defined as the state of the vehicle 100 in which full electrical energy is provided to more electrical components than in the off state and the vehicle 100 is not ready to be driven. Typically, an operator puts the vehicle 100 into the on state when the operator is going to drive the vehicle 100, puts the vehicle 100 into the off state when the operator is going to leave the vehicle 100, and puts the vehicle 100 into the accessory-power state when the operator is going to sit in but not drive the vehicle 100. In response to the vehicle 100 being in the on state, the process 300 returns to the block 305. In response to the vehicle 100 being in the off state or the accessory-power state, the process 300 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. Operations, systems, and methods described herein should always be implemented and/or performed in accordance with an applicable owner's/user's manual and/or safety guidelines.

The disclosure has been described in an illustrative manner, and it is to be understood that the terminology which has been used is intended to be in the nature of words of description rather than of limitation. The adjectives “first,” “second,” and “third” are used throughout this document as identifiers and are not intended to signify importance, order, or quantity. Use of “in response to,” “upon determining,” etc. indicates a causal relationship, not merely a temporal relationship. Many modifications and variations of the present disclosure are possible in light of the above teachings, and the disclosure may be practiced otherwise than as specifically described.

What is claimed is:

1. A computer comprising a processor and a memory, the memory storing instructions executable by the processor to:
determine a weather classification for an environment surrounding a vehicle;
select a steering mode for the vehicle based on the weather classification, the steering mode being selected from a hands-free steering mode, a hands-on-wheel steering mode, and a manual steering mode; and
operate a steering system of the vehicle according to the selected steering mode.

2. The computer of claim 1, wherein the instructions further include instructions to block selection of the hands-free steering mode and block selection of the hands-on-wheel steering mode in response to the weather classification being severe weather.

3. The computer of claim 1, wherein the instructions further include instructions to block selection of the hands-free steering mode and permit selection of the hands-on-wheel steering mode in response to the weather classification being medium weather.

4. The computer of claim 1, wherein the instructions further include instructions to permit selection of the hands-free steering mode and permit selection of the hands-on-wheel steering mode in response to the weather classification being mild weather.

5. The computer of claim 1, wherein the instructions to determine the weather classification include instructions to select the weather classification from severe weather, medium weather, and mild weather.

6. The computer of claim 1, wherein the instructions further include instructions to determine a confidence value for detection of a road lane by a sensor on board the vehicle, and determine the weather classification based on the confidence value.

7. The computer of claim 1, wherein the instructions further include instructions to determine the weather classification based on inertial sensor data indicating motion of the vehicle.

8. The computer of claim 7, wherein the instructions further include instructions to determine a confidence value for detection of a road lane by a sensor on board the vehicle, and determine the weather classification based on an interaction between the confidence value and the inertial sensor data.

9. The computer of claim 1, wherein the instructions further include instructions to change the weather classification in response to sensor data satisfying an instantaneous condition for at least a minimum length of time within a preset time window.

10. The computer of claim 9, wherein the sensor data satisfying the instantaneous condition includes a confidence value for detection of a road lane by a sensor on board the vehicle.

11. The computer of claim 9, wherein the sensor data satisfying the instantaneous condition includes inertial sensor data indicating motion of the vehicle.

12. The computer of claim 9, wherein the sensor data satisfying the instantaneous condition includes perception data of the environment surrounding the vehicle.

13. The computer of claim 1, wherein the instructions further include instructions to operate the steering system to direct the vehicle toward a center of a lane of travel in response to the selected steering mode being the hands-free steering mode.

14. The computer of claim 1, wherein the instructions further include instructions to operate the steering system to direct the vehicle toward a center of a lane of travel in response to the selected steering mode being the hands-on-wheel steering mode.

15. A method comprising:
determining a weather classification for an environment surrounding a vehicle;
selecting a steering mode for the vehicle based on the weather classification, the steering mode being selected from a hands-free steering mode, a hands-on-wheel steering mode, and a manual steering mode; and
operating a steering system of the vehicle according to the selected steering mode.

16. The method of claim 15, further comprising blocking selection of the hands-free steering mode and blocking selection of the hands-on-wheel steering mode in response to the weather classification being severe weather.

17. The method of claim 15, further comprising blocking selection of the hands-free steering mode and permitting selection of the hands-on-wheel steering mode in response to the weather classification being medium weather.

18. The method of claim 15, further comprising permitting selection of the hands-free steering mode and permitting selection of the hands-on-wheel steering mode in response to the weather classification being mild weather.

19. The method of claim 15, further comprising changing the weather classification in response to sensor data satisfying an instantaneous condition for at least a minimum length of time within a preset time window.

20. The method of claim 15, further comprising operating the steering system to direct the vehicle toward a center of a lane of travel in response to the selected steering mode being one of the hands-free steering mode or the hands-on-wheel steering mode.
